(19) United States
(12) Patent Application Publication
(10) Pub. No.: US 2003/0089898 A1
(43) Pub. Date: May 15, 2003

(54) Screw nut holder for heavy-duty jack assembly

(76) Inventors: Shane A. Straw SR., Plover, WI (US); Christopher M. Morris, Schofield, WI (US)

Correspondence Address: ROBERT H. EARP,111, MCDONALD, HOPKINS, BURKE & HABER CO, L.P.A., 2100 BANK ONE CENTER, 600 SUPERIOR AVENUE, E., CLEVELAND, OH, 44114-2653, US

(21) Appl. No.: 10/024,925

(22) Filed: Dec. 19, 2001

Related U.S. Application Data
(60) Provisional application No. 60/336,150, filed on Nov. 15, 2001.

(51) Int. Cl. B60S 9/02

(52) U.S. Cl. 254/425

(57) ABSTRACT

A jack assembly for altering the height of an object such a recreational vehicle. The jack includes an outer tube secured to the vehicle and an inner tube having a ground engaging portion and telescopingly received within the outer tube. An axial screw operably connected to a crank at the top of the jack extends through the tubes for altering the length of the jack. The screw threadably engages a screw nut mounted within the inner tube. In order to reduce the material volume of the screw nut, the nut is positionally captured within a retainer seated within the lower tube The retainer is configured to seat within the upper end of the lower tube and includes a slot for receiving the screw nut. The nut and the retainer include corresponding flats to prevent rotation of the nut within the retainer.

### RELATED APPLICATIONS

This application claims priority from U.S. Provisional Application No. 60/336,150 filed on Nov. 15, 2001.

### BACKGROUND OF THE INVENTION

I. Field of the Invention

This invention relates to mechanical jacks for raising and lowering vehicles such as a portion of a trailer and, in particular, to a retainer for a large capacity screw nut used to telescopingly adjust the jack assembly.

II. Description of the Prior Art

Mechanical jacks are convenient devices for raising and lowering a portion of a vehicle such as the tongue or forward portion of a trailer. The forward portion may need to be raised or lowered to level the trailer or to position the trailer coupler for connection to the towing vehicle. Typical jacks include telescoping sections, the extension and retraction of which is controlled by an axial screw extending through the housing and drivably engaging a screw nut. Rotation of the screw within the jack may be controlled directly by a crank or through a gear assembly drivably connecting the crank to the screw. Rotation of the crank in one direction rotates the screw causing expansion of the jack sections as the screw nut travels along the screw. Conversely, rotation of the crank in the opposite direction causes contraction of the jack sections as the screw nut travels along the screw in the opposite direction.

In heavy-duty lifting applications such as with large trailers or similar recreational vehicles, the threaded interaction between the screw and screw nut requires the use of stronger materials to prevent wear and stripping of the threads which may shorten the life of the jack. The use of more durable materials increases the manufacturing costs particularly with respect to the screw nut which must span the width of the jack tube in order to be secured in the tube. The screw nut must be fixed against rotation within the walls of the tube. The greater the rated capacity of the jack the larger the jack tube requiring a corresponding screw nut.

### SUMMARY OF THE PRESENT INVENTION

The present invention overcomes the disadvantages of the prior known jack assemblies by providing a fixed holder for the screw nut facilitating the use of a smaller nut manufactured of a superior material to reduce the cost of manufacturing the jack assembly.

The jack assembly of the present invention includes telescoping tube members for selective expansion and contraction. The lower, typically inner, tube includes a ground engaging portion and the upper or outer tube is secured to the vehicle. An axial screw extends through the tubes and is drivably connected to a crank at the top of the jack. Rotation of the crank will correspondingly rotate the axial screw within the tube housings.

In order to telescopingly expand the jack tubes, the screw threadably engages a screw nut fixedly secured within the lower tube. Rotation of the screw will drive the screw nut up and down the screw as required However, rather than secure the screw directly to the tube which would require a nut of substantial volume and diameter, a nut retainer is provided. The retainer has a circumferential configuration corresponding to the configuration of the tube so as to be seated within an upper end of the lower tube. The retainer includes flanges along its periphery designed to sit on top of the tube. The flanges do not extend beyond the periphery of the tube allowing the lower tube and the retainer to move within the upper or outer tube. At least one shoulder is formed in the retainer allowing it to be stacked within the tube.

The nut retainer includes a slot open to an edge of the retainer for receiving the screw nut. The slot has upper and lower shoulders to capture the screw nut against vertical movement within the retainer. In a preferred embodiment, both screw nut and the retainer slot both include flats for preventing rotating of the nut within the retainer. Thus, although the screw nut floats within the retainer it is prevented from rotating allowing the nut and the tube to be driven by the axial screw. The jack screw extends through the center of the nut and the retainer such that rotation of the screw will drive the screw nut. Since the screw nut is positioned within the retainer, the reduced diameter and volume of the nut allows it to be more cost-effectively manufactured from more durable materials improving the life of the jack.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a jack assembly embodying the present invention for use in mechanically raising and lowering a device;

FIG. 2 is a perspective view of a screw nut retainer mounted within a tube of the jack assembly;

FIG. 3 is an exploded view thereof;

FIG. 4 is an assembled view thereof prior to securing the retainer within the jack tube;

FIG. 5 is an enlarged perspective of the screw nut; and

FIG. 6 is a perspective of the retainer.

### DETAILED DESCRIPTION OF A PREFERRED EMBODIMENT OF THE PRESENT INVENTION

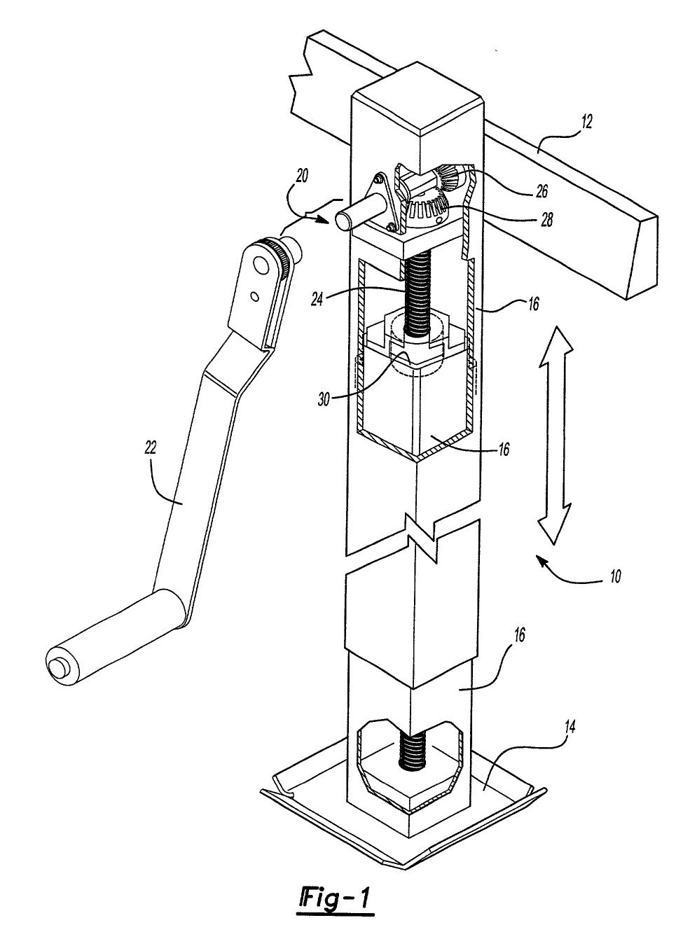

Referring first to FIG. 1, there is shown a jack assembly 10 secured to an object 12 for selectively lowering and raising the object 12. For example, the object could be the tongue of a trailer which then may be raised and lowered as needed. The jack 10 is secured to the object 12 in a conventional manner and includes a ground engaging foot 14. The jack assembly 10 is designed to be telescopingly expanded and contracted to correspondingly raise and lower the object 12.

The jack assembly 10 generally includes a firsts lower tube housing 16 secured to the foot 14 and a second upper tube housing 18 secured to the object 12. In a conventional manner, the lower tube 16 is telescopically received within the upper tube 18 for extension and contraction of the jack assembly 10. The jack tubes 16,18 shown in the drawing have a square cross-sectional configuration although different configurations may be employed. Disposed at the upper end of the outer jack tube 18 is a drive assembly 20 for transmitting rotation of an external crank 22 to an axial screw 24 extending substantially the length of the jack 10. A top mounted crank 22 would directly drive the screw 24 through a direct axial connection. Alternatively, in a side mounted crank 22 as shown in FIG. 1, the drive assembly 20 includes cooperating beveled gears, a first gear 26 and drivably connected to the axial screw 24. The screw 24 is threaded along its entire length which controls the length of extension for the jack assembly 10.

Referring now to FIGS. 1 through 4, seated in an upper end 30 of the lower or inner jack tube 16 is a screw nut assembly 32 designed to drivably cooperate with the screw 24. The screw nut assembly 32 includes a screw nut 34 (FIG. 5) positionally captured within a screw nut retainer 36 (FIG. 6). The screw nut assembly 32 is secured, preferably staked, within the upper end 30 of the lower tube 16 as will be subsequently described.

In accordance with the present invention, the screw nut 34 has a diameter which is substantially smaller than the diameter of the jack tube 16. By utilizing a screw nut 34 which has a reduced diameter and volume, a superior material can be used in the manufacture of the nut 34 without a corresponding increase in manufacturing costs. The screw nut 34 has an axial throughbore 38 which is threaded and the stronger material composition improves the reliability of the threaded connection with the screw 24 In a preferred embodiment, the nut 34 includes at least two flats 40 on the exterior of the nut 34 to prevent rotation within the retainer 36 as will be described.

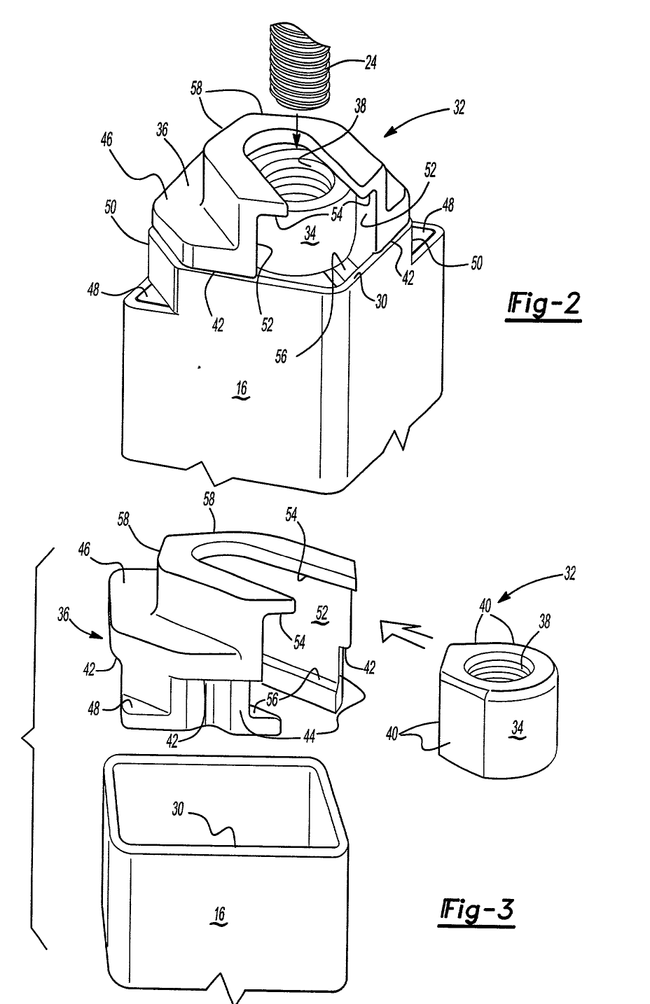

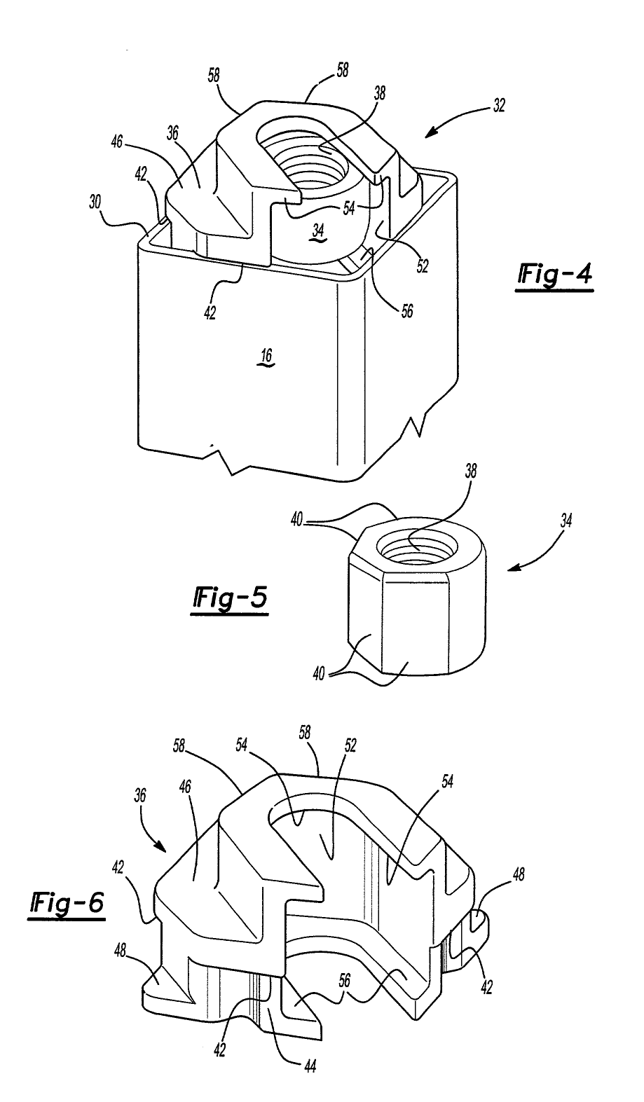

The screw nut retainer 36 is configured to be seated within the upper end 30 of the tube 16. As is best shown in FIGS. 2 and 4 of the embodiment depicted, the circumferential configuration of the retainer 36 corresponds to the square tube 16. Formed along the peripheral edges of the retainer 36 are a series of flanges 42 having a width corresponding to the width tube wall 16. The flanges 42 divide the retainer 36 into a lower portion 44 which is received within the tube 16 and an upper portion 46 which is maintained above the end 30 of the tube 16. The flanges 42 sit on the top 30 of the jack tube 16 such that the retainer 36 is supported on the end 30 of the tube 16. Formed at at least two corners of the retainer 36 are shoulders 48 which, after staking the corner 50 of the jack tube 16, prevents withdrawal of the retainer 36 from the tube 16.

The screw nut retainer 36 includes a slot 52 open to one peripheral edge of the retainer 36 for insertion of the screw nut 34. The slot 52 is defined by upper shoulders 54 and lower shoulders 56 which are spaced according to the height of the screw nut 34 allowing it to slide into the slot 52 but not providing excessive vertical play. The width of the slot 52 corresponds to the width of the nut 34, preferably opposing flat surfaces 40 of the nut 34. To further eliminate rotation of the nut 34 within the retainer 36, the closed end of the slot 52 may include additional flat surfaces 58 to engage flats 40 on the screw nut 34. The slot 52 is configured to allow the screw 24 to pass between the upper shoulders 54, through the nut 34 and between the lower shoulders 56 into the lower tube 16.

Assembly of the screw nut holder 32 facilitates deployment of a screw nut 34 of reduced diameter and volume allowing use of stronger or costlier materials in the manufacture of the nut 34. The screw nut 34 is slid into the slot 52 of the nut retainer 36 until it engages the end of the slot 52 and the flats 40 of the screw nut 34 engage the flats 58 of the slot 52. The screw retainer 36 holding the screw nut 34 is then seated within the top of the jack tube 16 until the flanges 42 engage the top of the tube 16. Properly positioned, the corners 50 of the tube 16 can then be staked preventing removal of the retainer 36 from the lower tube 16. Upon telescoping assembly of the lower tube 16 into the upper tube 18, the jack screw 24 will be threadably fed through the screw nut 34 substantially as shown in FIG. 1. As the jack screw 24 is rotated, the screw nut 34, which is prevented from rotating within the retainer 36, will be driven up or down the jack screw 24 causing the jack assembly 10 to contract or extend correspondingly. The nut retainer 36 of the present invention allows a screw nut 34 of limited size to be deployed in even heavy-duty jack assemblies 10 which will employ larger jack tubes 16,18 than conventional jacks.

The foregoing detailed description has been given for clearness of understanding only and no unnecessary limitations should be understood therefrom as some modifications will be obvious to those skilled in the art without departing from the scope and spirit of the appended claims.

What is claimed is:

1. A selectively extensible jack assembly comprising:
an upper jack tube adapted to be connected to a structure;
a lower jack tube telescopically engaging said upper jack tube, said lower jack tube including a ground engaging member;
a jack screw axially disposed within said upper and said lower jack tube;
means drivably connected to said jack screw for selectively rotating said jack screw in a first and a second direction; and
a screw nut threadably engaging said jack screw, said screw nut positionally captured within a nut retainer seated within an upper end of said lower jack tube wherein rotation of said jack screw in said first direction will drive said screw nut and said retainer downwardly telescopically extending said jack assembly and rotation of said jack screw in said second direction will move said screw nut and said retainer upwardly telescopically contracting said jack assembly.

2. The jack assembly as defined in claim 1 wherein said screw nut has a diameter substantially less than the diameter of said lower jack tube.

3. The jack assembly as defined in claim 2 wherein said nut retainer has a circumferential configuration corresponding to a cross-sectional configuration of said lower jack tube.

4. The jack assembly as defined in claim 3 wherein said nut retainer includes a lateral slot open to one edge of said nut retainer, said slot formed by upper and lower spaced apart shoulders and side walls, said screw nut positionally captured within said slot.

5. The jack assembly as defined in claim 4 wherein said screw nut has a plurality of flat edges and said slot of said nut retainer has a corresponding plurality of flat surfaces formed in said side walls of said slot, said flat surfaces engaging said flat edges to prevent rotation of said screw nut within said retainer.

6. The jack assembly as defined in claim 3 wherein said retainer nut includes at least one peripheral flange, said at least one peripheral flange engaging the top of said lower jack tube upon seating of said retainer within said lower jack tube.

7. The jack assembly as defined in claim 6 and further comprising at least one shoulder formed in said retainer, said jack tube engaging said at least one shoulder to prevent withdrawal of said retainer from said lower jack tube.

8. A selectively extensible jack assembly comprising:
an upper jack tube adapted to be connected to a structure;
a lower jack tube telescopically received within said upper jack tube, said lower jack tube including a ground engaging member;
a jack screw extending axially through said upper and said lower jack tube;
drive means connected to said jack screw for selectively rotating said jack screw in a first direction and a second direction; and
a screw nut threadably engaging said jack screw, said screw nut having a diameter substantially smaller than a diameter of said lower jack tube, said screw nut positionally captured within a nut retainer, said nut retainer nestingly received within an upper end of said lower jack tube and disposed within said upper jack tube wherein rotation of said jack screw in said first direction will drive said screw nut and said retainer downwardly to telescopically extend said jack assembly and rotation of said jack screw in said second direction will move said screw nut and said retainer upwardly along said jack screw to telescopically contract said jack assembly.

9. The jack assembly as defined in claim 8 wherein said nut retainer has a circumferential configuration corresponding to a cross-sectional configuration of said lower jack tube.

10. The jack assembly as defined in claim 9 wherein said nut retainer includes a lateral slot open to one edge of said nut retainer, said slot formed by upper and lower spaced apart shoulders and side walls, said screw nut positionally captured within said slot.

11. The jack assembly as defined in claim 10 wherein said screw nut has a plurality of flat edges and said slot of said nut retainer has a corresponding plurality of flat surfaces formed in said side walls of said slot, said flat surfaces engaging said flat edges to prevent rotation of said screw nut within said retainer.

12. The jack assembly as defined in claim 11 wherein said retainer nut includes at least one peripheral flange, said at least one peripheral flange engaging the top of said lower jack tube upon seating of said retainer within said lower jack tube.

13. The jack assembly as defined in claim 12 and further comprising at least one shoulder formed in said retainer, said jack tube engaging said at least one shoulder to prevent withdrawal of said retainer from said lower jack tube.
